(19) United States
(12) Patent Application Publication
(10) Pub. No.: US 2022/0129851 A1
(43) Pub. Date: Apr. 28, 2022

(54) SYSTEM AND METHOD FOR MAKING STRATEGIES AND GENERATING CUSTOMIZED REPORTS BASED ON USERS IN REAL-TIME

(71) Applicants: VIVEK MISHRA, Lucknow (IN); ROMIL SHAH, Mumbai (IN)

(72) Inventors: VIVEK MISHRA, Lucknow (IN); ROMIL SHAH, Mumbai (IN)

(21) Appl. No.: 17/567,884

(22) Filed: Jan. 4, 2022

(30) Foreign Application Priority Data
Sep. 21, 2020 (IN) 202121042693

(51) Int. Cl. G06Q 10/10

(52) U.S. Cl. CPC G06Q 10/10; G06F 40/30

(57) ABSTRACT

Exemplary embodiments of the present disclosure are directed towards a system and method for making strategies and generating customized reports based on users in real-time, comprising: computing device comprising strategy making and customized report generating module configured to deploy agents in interaction layer where users interact with customized reports. Strategy making and customized report generating module configured to capture variety of information related to users and knowledge base database configured to store information required to generate customized reports in different ways for users on computing device. The knowledge base database resides strategy processor configured to decide strategies. The strategy processor configured to decide structural properties for insights and send structural properties to knowledge base database. The strategy processor configured to share customized reports with the users on the computing device and the agents deployed on interaction layer records how users interact with customized reports and start learning from customized reports.

### CROSS-REFERENCE TO RELATED APPLICATIONS

This patent application claims priority benefit of Indian Complete Patent Application No: 202121042693, entitled “SYSTEM AND METHOD FOR MAKING STRATEGIES AND GENERATING CUSTOMIZED REPORTS BASED ON USERS IN REAL-TIME”, filed on 21Sep. 2021. The entire contents of the patent application is hereby incorporated by reference herein in its entirety.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter relates generally to system and computer implemented methods for making changes to the strategies. More particularly, the present disclosure relates to a system and method for making strategies and generating customized reports in real-time based on user interaction data and user feedback data.

### BACKGROUND

Business organizations need decisions about strategies repeatedly. A decision is strategic if it defines, maintains, or changes an organization's mission, scope and/or differentiation. To achieve goals, missions and objectives, the organization must constantly make decisions and take actions based on those decisions. In a typical organization, a host of decisions take place at all levels of the organization on the recurring basis. In this digital age, reporting and business intelligence tools are at the center of all data-oriented organizations. With data being the new age gold, there is a shift in business organizations worldwide to make data backed decisions. To help the employees with this decision-making process, the business organizations have spent huge sums of money on creating dashboards, which show the users what is happening in the business. These dashboards remain the same for all the different types of users, be it the CEO or a factory level worker. This is where these reporting mechanisms fall short.

The dashboards provide the same view of the entire business to all its viewers, as well as being the same and showing similar kind of information over a period of time. One way to tackle this is by having a workforce of people sitting and churning out these reports, to add context to them or to update the dashboards being used continuously so that they are up to date with the current trends. Although achievable, this may cost serious amounts of money to any business organization added to the already costly business intelligence licenses. This leaves the decision-making process prone to human error/misjudgment. There are chances of different people looking at the same thing coming to different conclusions. All of this further delay the decision-making process and can lead to significant losses in the long run. Despite efforts to integrate various data sources of business organizations, the decision-makers may not have access to rapid, consistent information about other decisions that have taken place, or that are proposed to take place, within the organization. The available systems cannot solve the problem by looking at all the data like a human would and come up with actions to take. Also, the existing systems are not providing a reason for what has happened and why was a particular decision necessary. The existing systems cannot change structural properties of a narrative based insights and cannot make any narrative based insights in reports to decrease a communication gap with different group of users in the same business organization.

In the light of the aforementioned discussion, there exists a need for a certain system with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards customizing different reports for different group of users, making sure that the insights are presented in a way that appeal to that user group the most, prompting them to take faster actions resulting in better chances of increasing the success/profit earned out of any changes implemented based on the decisions taken from these reports.

Another objective of the present disclosure is directed towards the system that changes the structural properties like tone, verbosity, assertiveness, etc. of a narrative based insight to decrease communication gap with different groups in the same organization.

Another objective of the present disclosure is directed towards the system intents to make sure that the narrative based insights in the report are communicated in a way that is most easily understandable to that group of users so that the through their actions the business goals are met more effectively.

Another objective of the present disclosure is directed towards the system that helps the users meet business goals by quickly adapting to the reporting style, and to decrease communication gap.

Another objective of the present disclosure is directed towards the system that collects information about the actions being executed and how is it impacting the improvements in achieving the business goals.

Another objective of the present disclosure is directed towards the system that stores all the information required to generate customized reports in different ways for the user, from analysing the input data to changing the language attributes of the generate insights.

Another objective of the present disclosure is directed towards the system that decides the strategy using which the knowledge base generated insights may be modified and presented to the user to get the user to take better actions to achieve business goals.

Another objective of the present disclosure is directed towards the system that interacts with the knowledge base to get the right communication models that may ensure the best rewards.

Another objective of the present disclosure is directed toward the system that shares the customized reports with the users, and the agent deployed on the client environment starts recording how the user interacts with the report and start learning from it.

Another objective of the present disclosure is directed towards the system that captures implicit as well as explicit variables from the user as well as the report and sends them back to a policy database as a feedback to the current set of strategies and communication policies, are chosen.

Another objective of the present disclosure is directed towards the system that updates the short-term strategies, medium-term strategies, long-term strategies based on the feedback while also updating the knowledge base for language policy changes that are necessary.

Another objective of the present disclosure is directed towards the system that learns faster by collectively learning which policy worked for which set of user and then tries to implement the same on another similar set of users, by making a few modifications.

Another objective of the present disclosure is directed towards the system that starts collecting user information and learning on past reports for all the users and how have they reacted to them.

Another objective of the present disclosure is directed towards the system that learns all the information and updates the related information in the knowledge database as well as its own memory store.

Another objective of the present disclosure is directed towards the system that keeps learning and updating the reports and reporting style so as to improve achievement of the business goal over time.

Another objective of the present disclosure is directed towards the system that checks with various strategies as to how well make the report and decide language semantic perform.

Another objective of the present disclosure is directed towards the system that makes changes to strategies based on the calculations.

Another objective of the present disclosure is directed towards the system that executes more actions buy or sell to help the users achieve better profits in the long run while also balancing short term loss risks.

Exemplary embodiments of the system and method for making strategies and generating customized reports based on users in real-time.

According to an exemplary aspect of the present disclosure, the system comprising a computing device comprising a strategy making and customized report generating module configured to deploy one or more agents in an interaction layer where one or more users interact with one or more customized reports, the strategy making and customized report generating module configured to capture a variety of information related to the one or more users.

According to another exemplary aspect of the present disclosure, the system comprising a knowledge base database configured to store the information required to generate the one or more customized reports in different ways for the one or more users on the computing device, the knowledge base database resides a strategy processor configured to decide one or more strategies by at least one of: looking at past data learned over time through a plurality of resources which is stored in the knowledge base database; and by taking inputs from the one or more users at the start of a deployment phase on the computing device; one or more feedbacks collected by the one or more agents in the interaction layer are passed on to the strategy processor.

According to another exemplary aspect of the present disclosure, the strategy processor configured to store and use the one or more feedbacks and to update the one or more strategies as and when required; the strategy processor also configured to decide one or more structural properties for one or more insights and send the one or more structural properties to the knowledge base database.

According to another exemplary aspect of the present disclosure, the knowledge base database configured to update the one or more insights and the one or more customized reports as per one or more language strategy tables.

According to another exemplary aspect of the present disclosure, the strategy processor configured to share the one or more customized reports with the one or more users on the computing device and the one or more agents deployed on the interaction layer configured to record how the one or more users interacts with the one or more customized reports and start learning from the one or more customized reports.

According to another exemplary aspect of the present disclosure, the one or more agents captures implicit as well as explicit variables from the one or more users as well the one or more customized reports and sends the one or more customized reports to the strategy processor as the one or more feedbacks to the one or more strategies and one or more communication policies, are chosen.

### BRIEF DESCRIPTION OF THE DRAWINGS

FIG. 1 is a block diagram depicting a schematic representation of a system for making changes to strategies and generating customized reports based on users, in accordance with one or more exemplary embodiments.

FIG. 2 is a block diagram depicting an embodiment of the strategy making and customized report generating module 108 shown in FIG. 1, in accordance with one or more exemplary embodiments.

FIG. 3 is a block diagram depicting another embodiment of the strategy making and customized report generating module 108 shown in FIG. 1, in accordance with one or more exemplary embodiments.

FIG. 4 is a flow diagram depicting a method for making strategies and generating customized reports based on users in real-time, in accordance with one or more exemplary embodiments.

FIG. 5 is a flow diagram depicting a method for updating the language strategy table in the knowledge base database to better suit the user profile, in accordance with one or more exemplary embodiments.

FIG. 6 is a flow diagram depicting a method for keep on updating the actions in the database, in accordance with one or more exemplary embodiments.

FIG. 7 is a flow diagram depicting a method for keep on updating the actions in the database, in accordance with one or more exemplary embodiments.

FIG. 8A, FIG. 8B are example diagrams depicting different ways of information screens, in accordance with one or more exemplary embodiments.

FIG. 8C, FIG. 8D are example diagrams depicting different report screens, in accordance with one or more exemplary embodiments.

FIG. 9 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

Referring to FIG. 1 is a block diagram 100 depicting a schematic representation of a system for making changes to strategies and generating customized reports based on users, in accordance with one or more exemplary embodiments. The system 100 includes a first computing device 102, a second computing device 104, a network 106, and a strategy making and customized report generating module 108. The first computing device 102 or second computing device 104 may be connected to the one or more computing devices via the network 106. The network 106 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure. The network 106 may be configured to provide access to different types of users. The computing device 102 may include, but is not limited to, a personal digital assistant, smartphones, personal computers, a mobile station, computing tablets, a handheld device, an internet enabled calling device, an internet enabled calling software, a telephone, a mobile phone, a digital processing system, and so forth. The strategy making and customized report generating module 108 is accessed as a mobile application, web application, software that offers the functionality of accessing mobile applications, and viewing/processing of interactive pages.

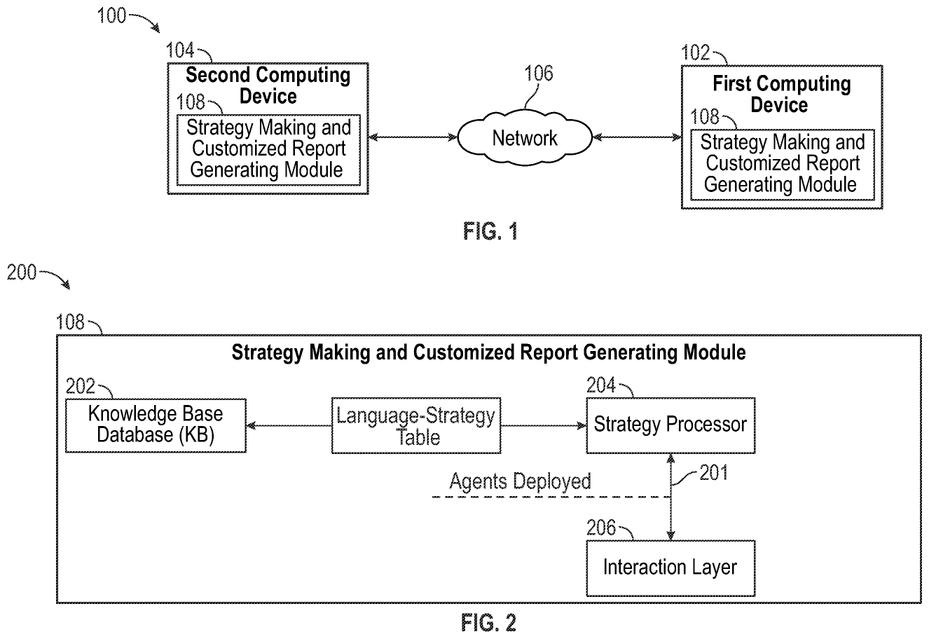

Although the first computing device 102 or second computing device 104 is shown in FIG. 1, an embodiment of the system 100 may support any number of computing devices. The first computing device 102 or second computing device 104 may be operated by the users. The users may include, but not limited to, employees, partners, workers, directors, decision makers, and the like. The first computing device 102 or second computing device 104 supported by the system 100 is realized as a computer-implemented or computer-based device having the hardware or firmware, software, and/or processing logic needed to carry out the computer-implemented methodologies described in more detail herein. The strategy making and customized report generating module 108 may include a database (shown in FIG. 2). The database (shown in FIG. 2) may be configured to hold digital data to make the strategies. The digital data may include, but not limited to, business data, learned data, metadata, mining data, user data, feedback, and the like. The database (shown in FIG. 2) may be the knowledge base database.

The strategy making and customized report generating module 108 may be configured to generate customized reports for different users and make sure that insights are presented in a way that appeal to that user group he most, prompting them to take faster actions resulting in better chances of increasing the success/profit earned out of any changes implemented based on the decisions taken from these customized reports on the first computing device 102 or second computing device 104. The customized reports, may include, but not limited to, portfolio analysis reports, narrative based insights in the reports, organization's reports, a first set of reports, the reports with recommended actions, change in the tone of reports, the verbosity changes of the insights in the reports, frequency and time of presenting the reports, the reports which contain insights about the events that have occurred and also the actions that need to be taken to achieve the goals, and the like. To ensure better and quicker decision making, the strategy making and customized report generating module 108 may be configured to change structural properties of a narrative based insight to decrease communication gap with different users in the same organization on the first computing device 102 or second computing device 104. The structural properties may include, but not limited to, tone, verbosity, assertiveness, flow, and the like. The strategy making and customized report generating module 108. The system 100 intent is to make sure that the narrative based insights in the customized report are communicated in a way that is most easily understandable to that the users so that the through their actions the business goals are met more effectively.

In accordance with one or more exemplary embodiments of the present disclosure, the strategy making and customized report generating module 108 may be configured to quickly adapt to reporting style, to decrease a communication gap by changing the way the report sounds, or by highlighting areas that the user needs to focus on by changing the structural properties with the end goal being how to make the user perform actions in a faster more efficient way to meet business goals to the users on the first computing device 102 or second computing device 104. An agent may be deployed in a client environment where the final users interact with the report on the first computing device 102 or second computing device 104. An agent may be a computer module, that sits on the client's computing device and captures different things like mouse movements, keystrokes, clicks, etc. and sends this information back to the strategy making and customized report generating module 108. The strategy making and customized report generating module 108 may be configured to capture a variety of information related to the users and the customized reports that they are consuming on the first computing device 102 or second computing device 104. The strategy making and customized report generating module 108 may be configured to learn quickly based on a feedback mechanism and make adjustments to how output is generated on the first computing device 102 or second computing device 104. The feedback mechanism may include, but not limited to, collecting information on how the users interact with the strategy making and customized report generating module 108 and how it impacts the business goals, and the like. The strategy making and customized report generating module 108 may be configured to keep learn and update the customized reports and reporting style to improve the achievement of the business goal over time, while the strategy making and customized report generating module 108 keeps learning and updating the business goals by using the industry knowledge stored in the knowledge base database 202 (shown in FIG. 2), as well as updating the strategies and communication policies.

Referring to FIG. 2 is a block diagram 200 depicting an embodiment of the strategy making and customized report generating module 108 shown in FIG. 1, in accordance with one or more exemplary embodiments. The strategy making and customized report generating module 108 includes a bus 201, a knowledge base database 202, a strategy processor 204, and an interaction layer 206. The bus 201 may include a path that permits communication among the modules of the strategy making and customized report generating module 108 installed on the first computing device 102 or second computing device 104. The term “module” is used broadly herein and refers generally to a program resident in the memory of the first computing device 102 or second computing device 104.

The knowledge base database 202 may be a centralized knowledge base configured to store all the information required to generate customized reports in different ways for the users, from analysing the input data to changing the language attributes of the generate insights on the first computing device 102 or second computing device 104. The knowledge base database 202 may be configured to house most of the information known to the strategy making and customized report generating module 108. The knowledge base database 202 may act as a memory to store all of the captured information which ranges from the user actions to the core decision framework models, and may keep learning from a wide variety of sources and also learns via a reinforcement learning technique by updating itself basis how impactful is the decision for each new event. The knowledge base database 202 may be configured to house all the domain knowledge by learning in different ways, be it online or through some user actions. The information houses numerous domains and helps make better decisions in a similar situation in various domains. The knowledge base database 202 may include a house analysis framework that includes various models and machine learning techniques, which help make sense of all the user events and data available throughout the system 100.

In accordance with one or more exemplary embodiments of the present disclosure, the strategy processor 204 may be configured to decide the strategy using the knowledge base database 202. Where the knowledge base database 202 may be configured to generate insights and the strategy processor 204 may be configured to modify the generated insights and present the insights to the user on the first computing device 102 or second computing device 104. The strategy processor 204 may include, but not limited to, a policy database, a policy processor, and the like. The strategy processor 204 may be enriched with the strategies that may help the strategy making and customized report generating module 108 define ideal semantics of a sentence to meet the business goals. The strategy processor 204 may be further configured to store additional information the client end agent collects which helps enrich the customized reports by incorporating patterns that are working or changing things that might not be having the best impact. In an example, the strategy processor 204 creates analysis customized reports for thousands of users. The end goal or the business goal is to get users to do certain actions (buy/sell) to balance the portfolio in a way that provides more profits. The knowledge about what and when to do these actions resides in the knowledge base database 202, which decides basis the data on what actions to recommend to each user.

In accordance with one or more exemplary embodiments of the present disclosure, the strategy processor 204 obtains the report and the list of actions to be presented to the user. The strategy processor 204 may be configured to take the list of actions into account the things that it has learned from the agent deployed at the client end, and the strategy that has been provided by experts or it has learned over time. The strategies may include, but not limited to, short-term strategies, medium-strategies, long-term strategies, and the like. Once the strategy is decided the strategy processor 204 interacts with the knowledge base database 202 to get the right communication models that may ensure the best reward (which is the most improvement in achieving the business goals). The customized reports are then shared with the users, and the agent deployed on the client environment starts recording how the user interacts with the report and starts learning from it. The agent captures both implicit as well as explicit variables from the user as well as the report and sends them back to the strategy processor 204 as feedback to the current set of strategies and communication policies, are chosen. Now, the knowledge base database 202 may be configured to update the strategies based on the feedback while also updating the knowledge base database 202 for language policy changes that are necessary.

In accordance with one or more exemplary embodiments of the present disclosure, the strategy making and customized report generating module 108 may be configured to learn faster by collectively learning which policy worked for which sets of user and then tries to implement the same on another similar set of users, by making a few modifications on the first computing device 102 or second computing device 104. For example, the agent starts collecting user information and learning on past reports for all the users and how have they reacted to them (carried out prescribed action or not). These learnings are then used to group similar people together and also help set the different strategies. As soon as the first set of customized reports go out to the users on the first computing device 102 or second computing device 104 along with recommended actions the user starts interacting differently with different parts of the report. The agent gathers all this information and passes it on to the strategy processor 204. The strategy processor 204 may be configured to learn on gathered information and updates the related information in the knowledge base database 202 as well as its memory store. Once this is done, the next time the customized reports get generated based on the updated strategies and communication goals.

In accordance with one or more exemplary embodiments of the present disclosure, the changes that may be seen in the report may include, but not limited to, changes in the tone of the recommendation, changes of verbosity of the insights, recommendation may be shifted up or down in the report, frequency and time of presenting the report, and the like. Change in the tone of the recommendation: the strategy making and customized report generating module 108 may give the user warning within the action recommendation language that shows to make the user execute the action which may be selling an underperforming asset in the short run, but also make sure that we may not make it sound to abusive to lose the user in the long run. The verbosity of the insights may be changed on the first computing device 102 or second computing device 104: some users need to read more detailed explanation for them to fully trust the recommendation, while some users like short crisp bullet points, this may be adjusted to ensure better acceptance of customized reports. Recommendation may be shifted up or down in the report, to be closer to the section that the users are spending most time on to attract more attention to it. Frequency and time of presenting the report may also be modified on the computing device according to the usage data of the users.

In accordance with one or more exemplary embodiments of the present disclosure, the interaction layer 206 may be configured to enable the user to interact on the first computing device 102 or second computing device 104. The user may get the customized reports or the narrative insights on the first computing device 102 or second computing device 104 through the interaction layer 206. The interaction layer 206mthrough which the user feedback or reactions on the output are captured to be used as feedback. The strategy processor 204 may be configured to house the most important components and carries out major tasks in the strategy making and customized report generating module 108. The strategy processor 204 may also be configured to decide the strategies and maintain and make sure the strategies are kept updated. The strategy processor 204 may decide the strategies by either looking at the past data learned over time through various resources which are stored in the knowledge base database 202 or by taking in inputs from the user at the start of the deployment phase. The feedback collected by the agents in the interaction layer 206 is passed on to the strategy processor 204 and the strategy processor 204 stores the feedback to update the strategies as and when required on the first computing device 102 or second computing device 104. Along with this, the strategy processor 204 may also be responsible to decide what kind of semantic and structural changes are to be made to the report. The semantic and structural changes may include, but not limited to, what tone may be used, how to structure the verbose may be the report be, and the like. Basis the decision made, the strategy processor 204 interacts with the knowledge base database 202 to bring sentences or customized reports in the right semantic structure to increase the chances of achieving the goals defined in the different strategies.

The knowledge base database 202 may be the central information store that is configured to store all worldly information about a wide set of topics and also house algorithms and rules which may learn on top of this information to generate better insights and suggest better actions to the user on the first computing device 102 or second computing device 104. The knowledge base database 202 may be configured to keep learning through the feedback collected by the agents deployed at the client end while also learning through other sources like online learning, and the like. The knowledge base database 202 may be responsible to generate the customized reports which contain both insights about the events that have occurred and also the actions that need to be taken to achieve the goals. These customized reports may be generated basis the data flowing into the system 100 from the client as well as taken into consideration the past data stored in the knowledge base database 202 or things learned through other sources. Along with these, the knowledge base database 202 may also be configured to house a language strategy table, which holds semantical information about how to construct a sentence if you want to be aggressive or if you want the report to sound more encouraging. The language strategy table may be used by the knowledge base database 202 to get the right sentences once it decides what semantic changes to make to the report to make a better impact on the reader.

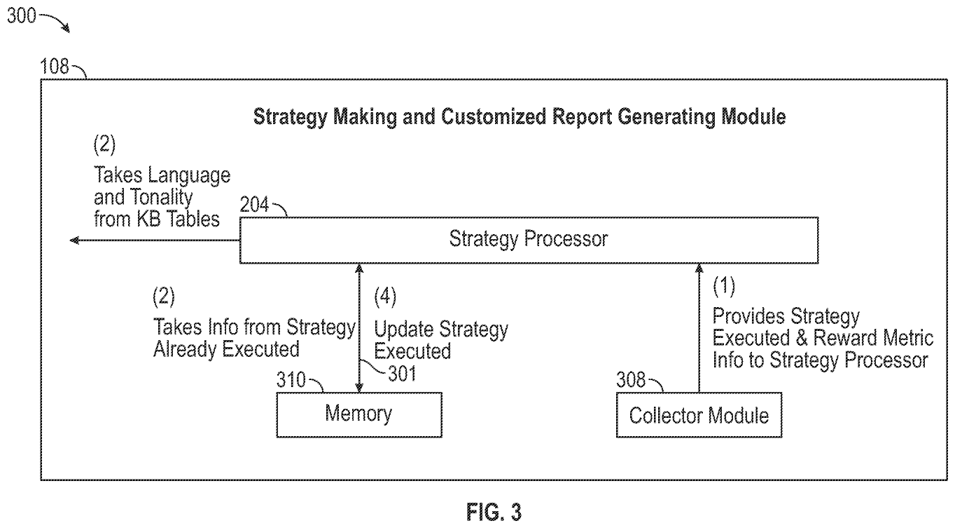

Referring to FIG. 3 is a block diagram 300 depicting another embodiment of the strategy making and customized report generating module 108 shown in FIG. 1, in accordance with one or more exemplary embodiments. The strategy making and customized report generating module 108 include the bus 301, the strategy processor 204, a collector module 308, and a memory 310. The bus 301 may include a path that permits communication among the modules of the strategy making and customized report generating module 108 installed on the first computing device 102 or second computing device 104. The term “module” is used broadly herein and refers generally to a program resident in the memory of the first computing device 102 or second computing device 104.

The collector module 308 may be the component that acts as an interface between the agents deployed on the interaction layer 206 and interacts with the users on the first computing device 102 or second computing device 104. The agents collect information about how the different users interact with the report and whether the last strategy and language implemented by the strategy processor 204. These metrics along with the strategy executed are passed on to the strategy processor 204 so that it may take better decisions while selecting the next set of strategies. The collector module 308 may be also configured to update the knowledge base database 202 with this information so that the insights being generated by the knowledge base may also be made better via learning from the feedback data. The memory 310 may be storage that houses past information about what strategies are executed and what may be the strategies on the first computing device 102 or second computing device 104. The strategy processor 204 may be configured to use memory 310 to check the history of executed results and design a better suited strategy taking into account all the past results. The memory 310 may also be configured to store the current decided strategies.

The strategy processor 204 may be configured to take computation and decision making about what strategy to be executed and what semantic changes are to be made to the report. The strategy processor 204 may be configured to house a set of proprietary algorithms, which may update strategies about the business based on the variety of inputs it receives along with algorithms that may decide what kind of semantic properties to use for a report to get that strategy executed for the best result. The strategy processor 204 may be configured to take in inputs from the collector module 308 about the impact of the last executed strategy, while also getting historic information from the memory 310. Along with this, the strategy processor 204 also gets the current strategies that need to be followed. Looking at all of the data the strategy processor 204 comes up with a semantic structure for the report to be published. Once these things are decided, the strategy processor 204 may be configured to send the decision to the knowledge base database 202, which then uses the language strategy table to change the insights generated on user data, to follow the semantic structure selected by the strategy processor 204. These insights may be sent to the interaction layer 206 via the strategy processor 204 and the agents start collecting data about these new customized reports. Along with this, the strategy processor 204, may also be configured to take in all the feedback data from the collector module 308 and the past data about the strategies executed, as well as any learnings about the user or the domain of the report that the knowledge base database 202 has acquired, and makes changes to the strategies to keep them up to date with the real world and saves them in the memory 310.

In accordance with one or more exemplary embodiments of the present disclosure, the portfolio performance report includes: agents may be deployed on the strategy making and customized report generating module 108 on which the user logs in to view portfolio performance report on the first computing device 102 or second computing device 104. The strategy making and customized report generating module 108 may be configured to learn from users related information as well as by asking inputs from the user to plan and decide the strategies. The policies may be then decided and stored in the memory 310. The knowledge base database 202 may be configured to use the user data coming in, which in this case may be how the user's portfolio is performing and what are the different stocks within it as well as any other related data that the knowledge base database 202 already has to generate relevant insights and actions. At the same time, the strategy processor 204 is configured to decide the language semantic of the report based on the decided strategy since in the first run there is no past data to learn from. These language semantics may also be based on the user and what has been his usual interaction with the system 100. For this case let's just decide that we may be using an encouraging tone and short crisp points to explain to the user the benefits of the suggested actions. The parameters may be passed to the knowledge base database 202 and with the help of the Language Strategy table the knowledge base database 202 may update the generated insights to suit the decided parameters. Once done the final report is then displayed to user on the first computing device 102 or second computing device 104 and the agents start collecting data around how the user is interacting with the report. For example, what buttons does the user clicks, which section of the report does the user spends the most time on, how many recommended actions does the user read/execute on the first computing device 102 or second computing device 104. The feedback data may be sent to the strategy processor 204 as well as the knowledge database 202.

In accordance with one or more exemplary embodiments of the present disclosure, the strategy processor 204 may be configured to check with various strategies as to how well does the report and decides language semantic perform on the first computing device 102 or second computing device 104. Basis these calculations the strategy processor 204 configured to make a change to the strategies so that decisions taken next time may be more accurate on the first computing device 102 or second computing device 104. The knowledge base database 202 may also be configured to take feedback and update the same feedback itself. In this example it's a portfolio performance report, so the user may choose to generate a report after a month or after just 2 days. The next time the user generates the report, the system 100 may be configured to take the old strategy parameters as well as the learnings from the feedback into account to generate better acceptable insights. This may result in a report with a similarly encouraging tone, but increasing the verbosity of the insights a little more to help the user understand it better. Also, instead of having action points at the very bottom of the report, we can have them in the middle, let's say after the 3rd section where the user usually spends most of his time. The system 100 may be configured to keep learning with each iteration for a single user as well as a group of users who may be grouped due to similar attributes and tries to improve the business goal, which in this case becomes getting the user to execute more actions like buying or sell to help the users achieve better profits in the long run while also balancing short term loss risks.

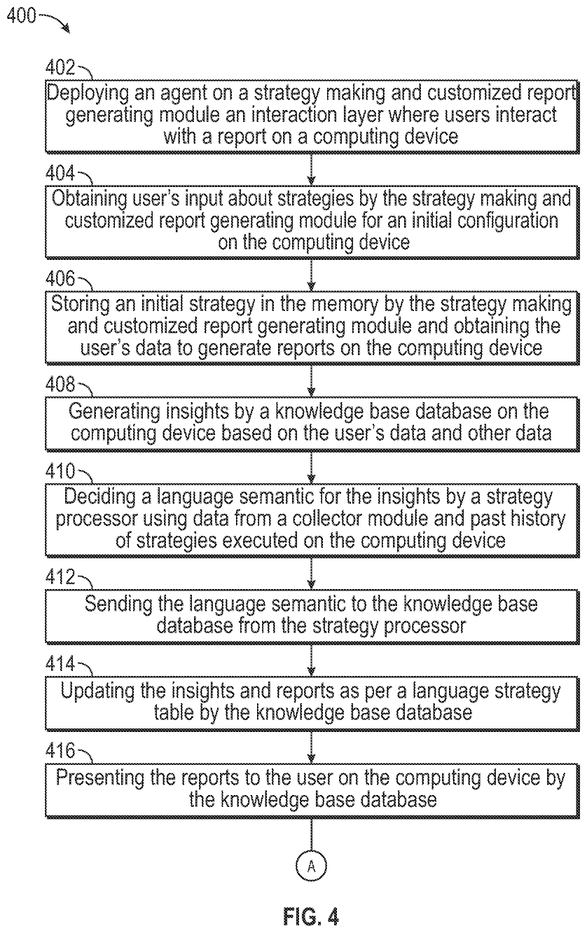

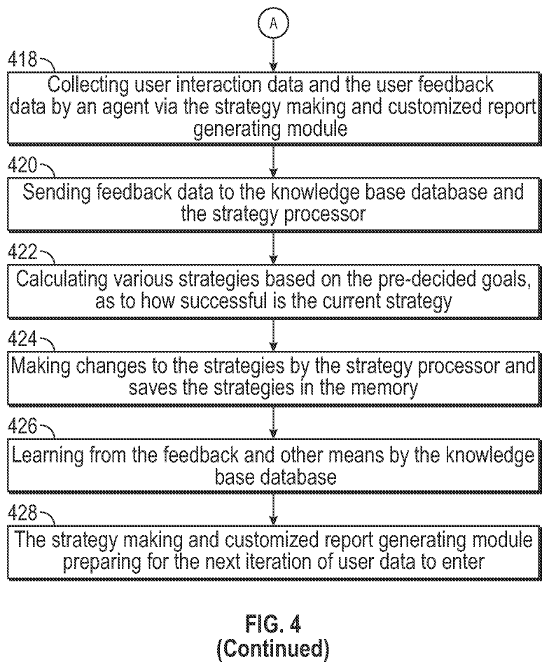

Referring to FIG. 4 is a flow diagram 400 depicting a method for making strategies and generating customized reports based on users in real-time, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method commences at step 402, the strategy making and customized report generating module deploy the agent in the client environment where the users interact with the report on the computing device. Thereafter, at step 404, the strategy making and customized report generating module obtain user's input about strategies for an initial configuration on the computing device. Thereafter, at step 406, the strategy making and customized report generating module store initial strategy in the memory and gets the user data to generate customized reports. Thereafter, at step 408, the knowledge base database generates insights on the computing device based on user's data and its other data. Thereafter, at step 410, the strategy processor decides language semantic for the insights, by using data from the collector module and past history of strategies executed on the computing device. The language semantic may include, but not limited to, tone, verbosity, assertiveness, flow, and the like.

Thereafter, at step 412, the strategy processor sends the decided semantic to knowledge base database. Thereafter, at step 414, the knowledge base database updates the insights and customized reports as per the language strategy table. Thereafter, at step 416, the knowledge base database presents the customized reports to the user on the computing device. Thereafter, at step 418, the agent collects via user interaction data and the user feedback data on the strategy making and customized report generating module. Thereafter, at step 420, feedback data is sent to the knowledge base database and the strategy processor. Thereafter, at step 422, the strategy processor calculates based on the pre-decided goals, as to how successful is the current strategy. Thereafter, at step 424, the strategy processor makes changes to the strategies and saves the strategies in the memory. Thereafter, at step 426, the knowledge base database also learns from the feedback and other means. Thereafter, at step 428, the strategy making and customized report generating module is ready for the next iteration of user data to enter.

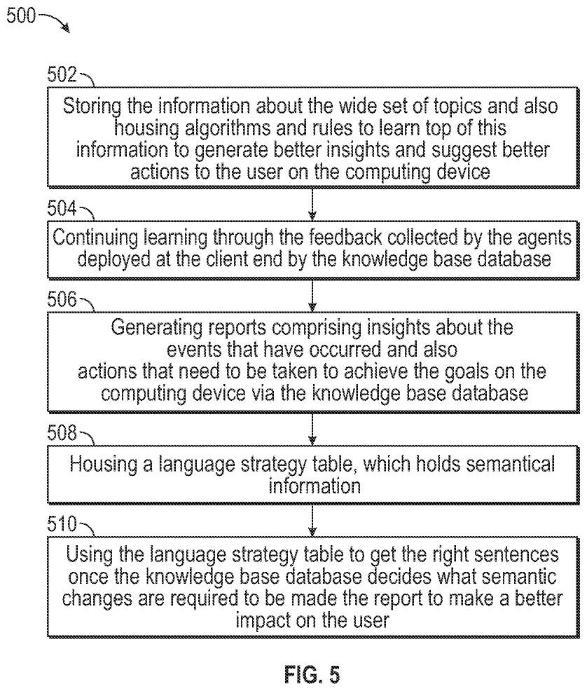

Referring to FIG. 5 is a flow diagram 500 depicting a method for updating the language strategy table in the knowledge base database to better suit the user profile, in accordance with one or more exemplary embodiments. The method 500 may be carried out in the context of the details of FIG. 1, FIG. 2, FIG. 3, and FIG. 4. However, the method 500 may also be carried out in any desired environment. Further, the aforementioned definitions may equally apply to the description below.

The method commences at step 502, the knowledge base database stores the information about the wide set of topics and also houses algorithms and rules to learn on top of this information to generate better insights and suggest better actions to the user on the computing device. Thereafter, at step 504, the knowledge base database continues learning through the feedback collected by the agents deployed at the client end. Thereafter, at step 506, the knowledge base database generates the customized reports comprising insights about the events that have occurred and also actions that need to be taken to achieve the goals on the computing device. Here, the customized reports are generated basis the data flowing into the strategy making and customized report generating module from the client as well as taken into consideration the past data stored in the knowledge base database or things learned through other sources. Thereafter, at step 508, the knowledge base database houses the language strategy table, which holds semantical information. Thereafter, at step 510, the knowledge base database uses the language strategy table to get the right sentences once the knowledge base database decides what semantic changes are required to be made to the report to make a better impact on the user.

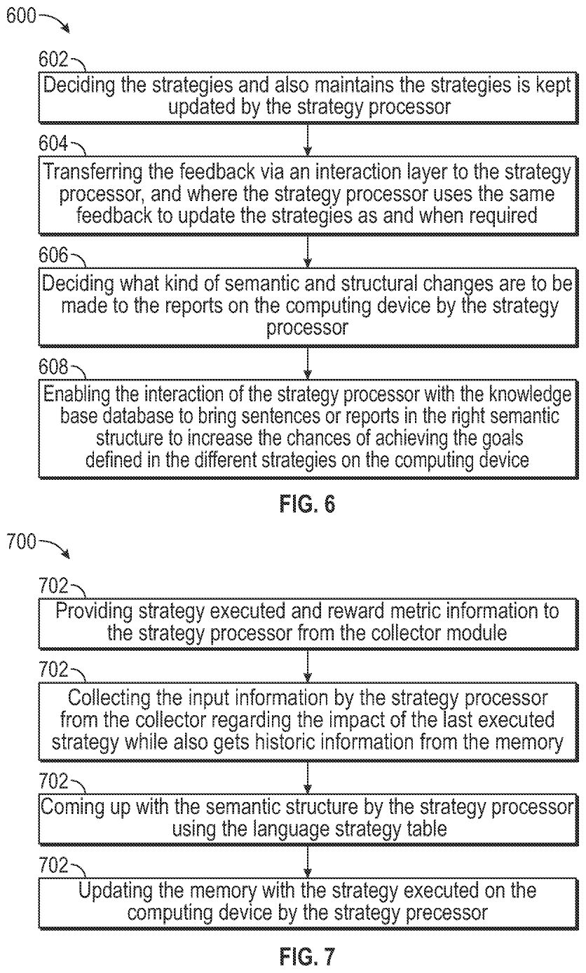

Referring to FIG. 6 is a flow diagram 600 depicting a method for keep on updating the actions in the database, in accordance with one or more exemplary embodiments. The method 600 may be carried out in the context of the details of FIG. 1, FIG. 2, FIG. 3, FIG. 4, and FIG. 5. However, the method 600 may also be carried out in any desired environment. Further, the aforementioned definitions may equally apply to the description below.

The method commences at step 602, the strategy processor decides the strategies and also maintains the strategies is kept updated. Here, the strategies include, but not limited to, long-term strategies, medium-term strategies, short-term strategies, and the like. The strategy processor decides the strategies by either looking at the past data learned over time through various resources or by taking in inputs from the business user at the start of the deployment phase. Thereafter, at step 604, transfers the feedback via the interaction layer to the strategy processor, where the strategy processor uses the same feedback to update the strategies as and when required. Thereafter, at step 606, the strategy processor further decides what kind of semantic and structural changes are to be made to the customized reports on the computing device. The semantic and structural changes may include, but not limited to, what tone may be used, how to structure the verbose may be the report be, and the like. Thereafter, at step 608, the strategy processor enables the interaction with the knowledge base database to bring sentences or customized reports in the right semantic structure to increase the chances of achieving the goals defined in the different strategies on the computing device.

Referring to FIG. 7 is a flow diagram 700 depicting a method for keep on updating the actions in the database, in accordance with one or more exemplary embodiments. The method 700 may be carried out in the context of the details of FIG. 1, FIG. 2, FIG. 3, FIG. 4, FIG. 5, and FIG. 6. However, the method 700 may also be carried out in any desired environment. Further, the aforementioned definitions may equally apply to the description below.

The method commences at step 702, the collector module provides strategy executed and reward metric information to the strategy processor. Thereafter, at step 704, the strategy processor collects input information from the collector regarding the impact of the last executed strategy while also gets historic information from the memory. Thereafter, at step 706, the strategy processor comes up with the semantic structure using the language strategy table. Thereafter, at step 708, the strategy processor updates the memory with the strategy executed on the computing device.

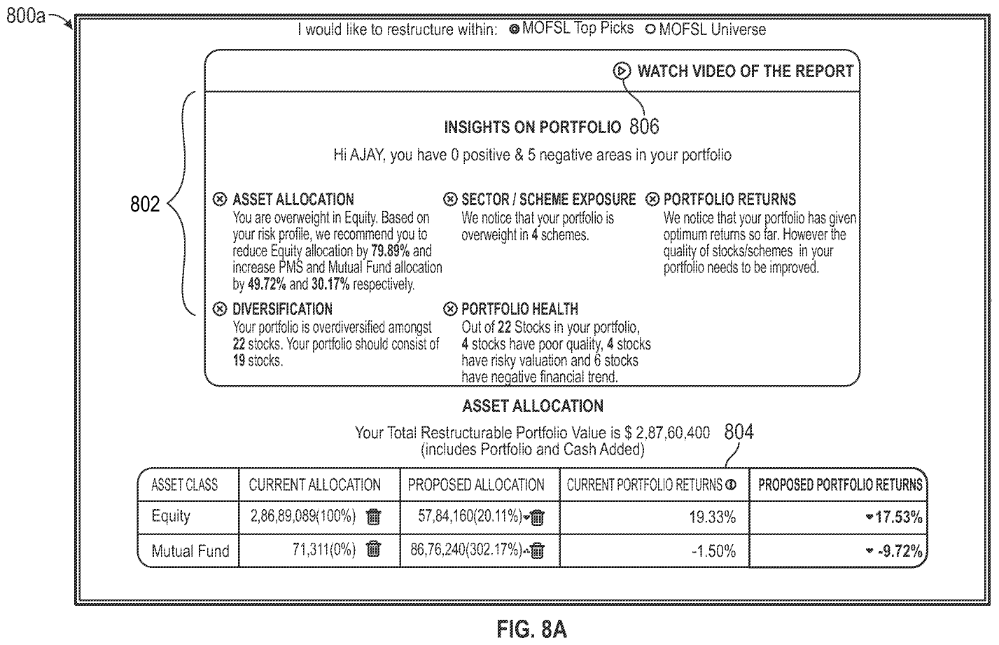

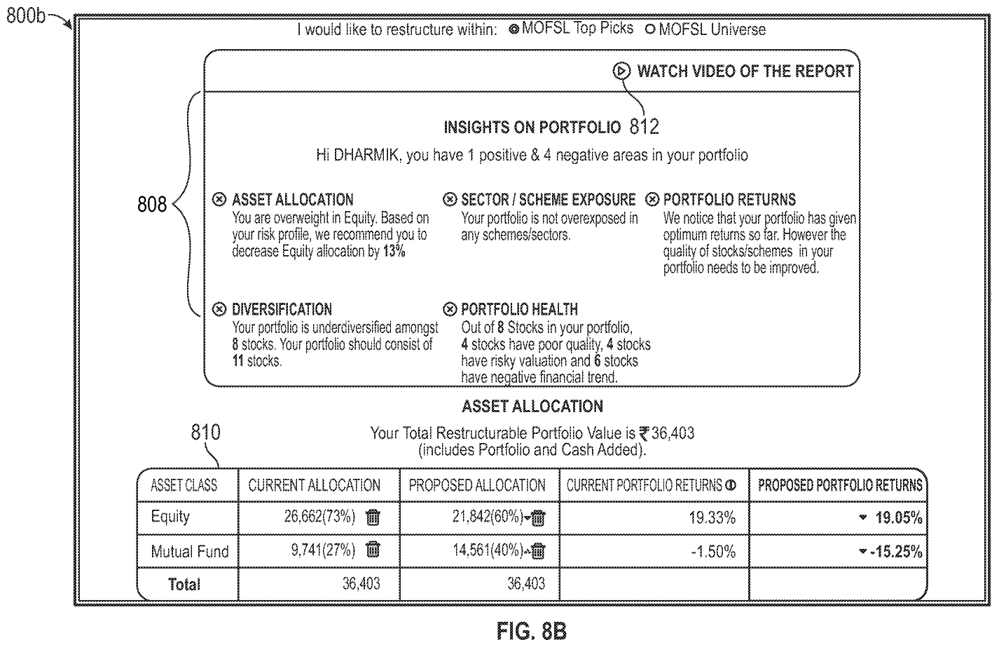

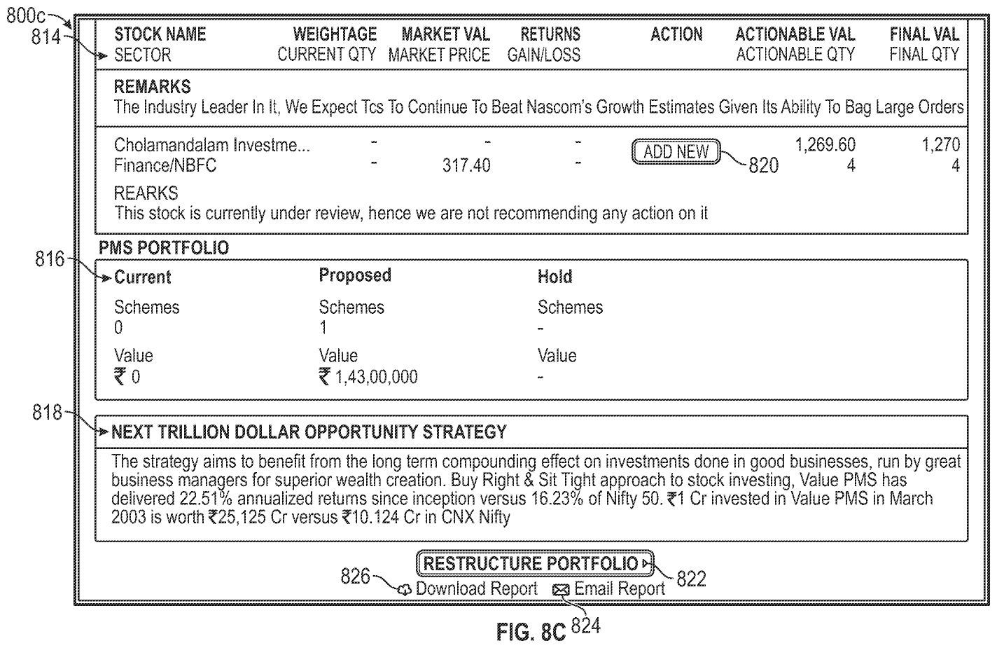

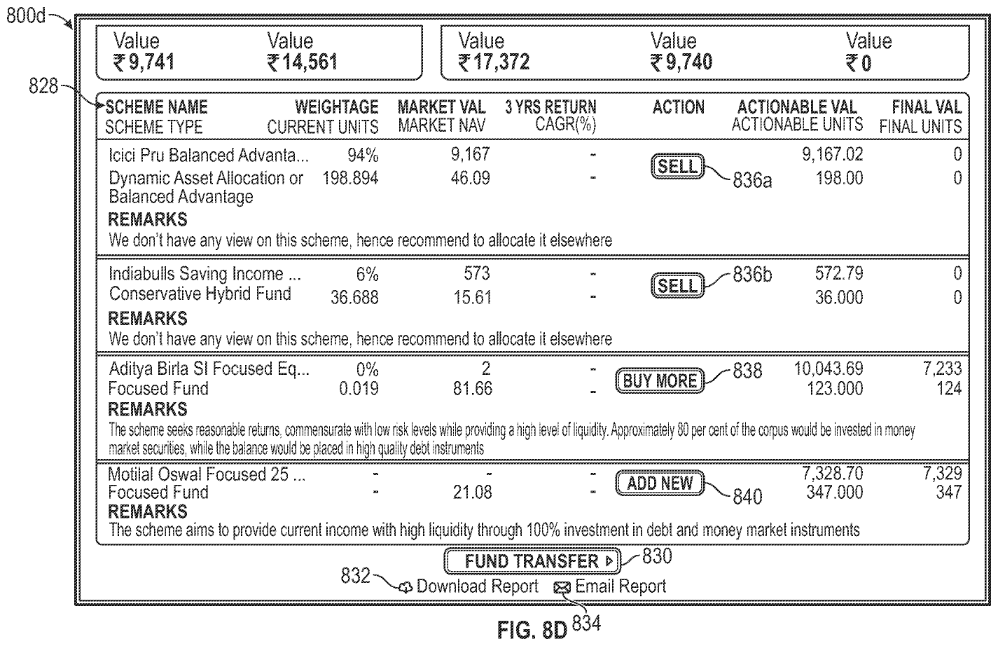

Referring to FIG. 8A, FIG. 8B are example diagrams 800a, 800b depicting different ways of information screens, in accordance with one or more exemplary embodiments. The different ways of information screens 800a, 800b may be described to different users on the first computing device 102 or the second computing device 104. The strategy making and customized report generating module 108 may be configured to generate insights and allocate the assets on the first computing device 102 or the second computing device 104. The information screen 800a includes a list of insights on portfolio 802, an asset allocation block 804. The list of insights on portfolio 802 may include negative insights. The negative insights may include, but not limited to, an asset allocation insight, a sector or scheme exposure insight, a portfolio return insight, a diversification insight, a portfolio health insight, and the like. The asset allocation block 804 may include total restructure portfolio value. The asset allocation block 804 may further include an asset class, a current allocation class, a proposed allocation class, a current portfolio return, a proposed portfolio return, and the like. The information screen 800a further includes a watch video of report option 806. If the user selects the video of report option 806, then the video report may appear on the first computing device 102 or the second computing device 104.

In accordance with one or more exemplary embodiments, the information screen 800b includes the list of insights on portfolio 808, the asset allocation block 810. The list of insights on portfolio 808 may include positive insights and negative insights. The positive insights and the negative insights may include, but not limited to, an asset allocation insight, a sector or scheme exposure insight, a portfolio return insight, a diversification insight, a portfolio health insight, and the like. The asset allocation block 810 may include total restructure portfolio value. The asset allocation block 804 may further include an asset class, a current allocation class, a proposed allocation class, a current portfolio return, a proposed portfolio return, and the like. The asset allocation block 810 may include total restructure portfolio value. The asset allocation block 810 may further include an asset class, a current allocation class, a proposed allocation class, a current portfolio return, a proposed portfolio return, and the like. The information screen 800b further includes a watch video of report option 812. If the user selects the video of report option 812, then the video report may appear on the first computing device 102 or the second computing device 104.

Referring to FIG. 8C, FIG. 8D are example diagrams 800c, 800d depicting different report screens, in accordance with one or more exemplary embodiments. The different report screen 800c includes a stock details block 814, a portfolio management block 816, a next dollar opportunity block 818, a restructure portfolio block 822, an email report option 824, and a download report option 826. The stock details block 814 includes a stock name, weightage, a market value, returns, action, an accountable value, a final value, and the like. The portfolio management block 816 includes a current list, a proposed list, and a hold list. The next dollar opportunity block 818 includes the dollar opportunity strategy. The stock details block 814 includes an add option 820 configured to enable the user to add stock details. The restructure portfolio block 822 may be configured to enable the user to restructure the portfolio on the first computing device 102 or the second computing device 104. The email report option 824 may be configured to enable the user to report the portfolio over the email to required users. The download report option 826 may be configured to enable the user to download the report on the first computing device 102 or the second computing device 104.

In accordance with one or more exemplary embodiments of the present disclosure, the different report screen 800d includes a scheme block 828, a fund transfer option 830, a download report option 832, and an email report option 834. The scheme block 828 includes sell options 836a, 836b, a buy more option 838, and an add new option 840. The scheme block 828 may include a list of scheme names, weightages, market values, returns, actions, actionable values, final values, and the like. The sell options 836a, 836b may be configured to enable the user on the first computing device 102 or the second computing device 104 to sell the different schemes. The buy more option 838 may be configured to enable the user on the first computing device 102 or the second computing device 104 to buy the different schemes from different companies. Furthermore, the add new option 840 may be configured to enable the user add other schemes. The fund transfer option 830 may be configured to enable the user to transfer the funds on the first computing device 102 or the second computing device 104 to other users. The download report option 832 may be configured to enable the user to download the current report on the first computing device 102 or the second computing device 104. The email report option 834 may be configured to enable the user to report the portfolio over the email.

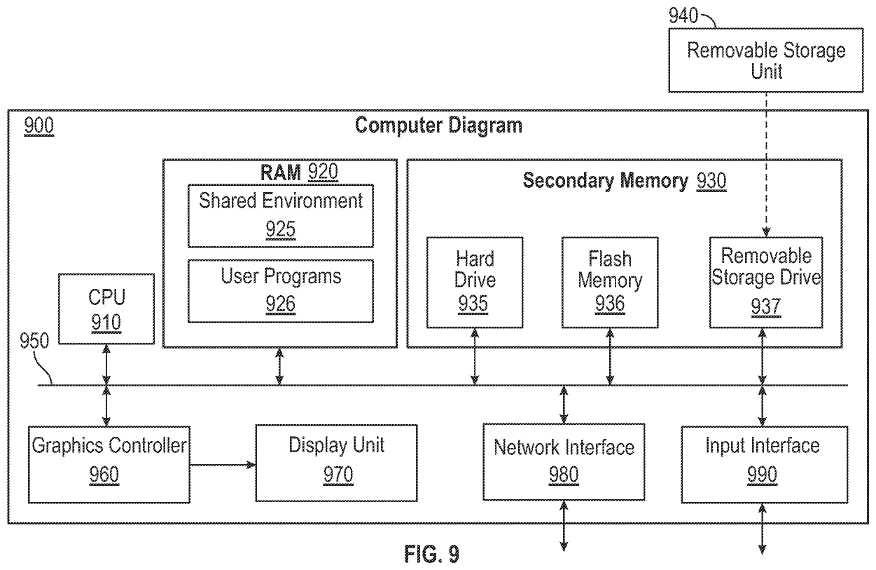

Referring to FIG. 9 is a block diagram 900 illustrating the details of a digital processing system 900 in which various aspects of the present disclosure are operative by execution of appropriate software instructions. The Digital processing system 900 may correspond to the first computing device 102 or second computing device 104 (or any other system in which the various features disclosed above can be implemented).

Digital processing system 900 may contain one or more processors such as a central processing unit (CPU) 910, random access memory (RAM) 920, secondary memory 930, graphics controller 960, display unit 970, network interface 980, and input interface 990. All the components except display unit 970 may communicate with each other over communication path 950, which may contain several buses as is well known in the relevant arts. The components of FIG. 9 are described below in further detail.

CPU 910 may execute instructions stored in RAM 920 to provide several features of the present disclosure. CPU 910 may contain multiple processing units, with each processing unit potentially being designed for a specific task. Alternatively, CPU 910 may contain only a single general-purpose processing unit.

RAM 920 may receive instructions from secondary memory 930 using communication path 950. RAM 920 is shown currently containing software instructions, such as those used in threads and stacks, constituting shared environment 925 and/or user programs 926. Shared environment 925 includes operating systems, device drivers, virtual machines, etc., which provide a (common) run time environment for execution of user programs 926.

Graphics controller 960 generates display signals (e.g., in RGB format) to display unit 970 based on data/instructions received from CPU 910. Display unit 970 contains a display screen to display the images defined by the display signals. Input interface 990 may correspond to a keyboard and a pointing device (e.g., touch-pad, mouse) and may be used to provide inputs. Network interface 980 provides connectivity to a network (e.g., using Internet Protocol), and may be used to communicate with other systems (such as those shown in FIG. 1) connected to the network 106.

Secondary memory 930 may contain hard drive 935, flash memory 936, and removable storage drive 937. Secondary memory 930 may store the data software instructions (e.g., for performing the actions noted above with respect to the Figures), which enable digital processing system 900 to provide several features in accordance with the present disclosure.

Some or all of the data and instructions may be provided on removable storage unit 940, and the data and instructions may be read and provided by removable storage drive 937 to CPU 910. Floppy drive, magnetic tape drive, CD-ROM drive, DVD Drive, Flash memory, removable memory chip (PCMCIA Card, EEPROM) are examples of such removable storage drive 937.

Removable storage unit 940 may be implemented using medium and storage format compatible with removable storage drive 937 such that removable storage drive 937 can read the data and instructions. Thus, removable storage unit 940 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 940 or hard disk installed in hard drive 935. These computer program products are means for providing software to digital processing system 900. CPU 910 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 930. Volatile media includes dynamic memory, such as RAM 920. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 950. Transmission media can also take the form of acoustic or light waves, such as those generated during radio-wave and infra-red data communications.

According to exemplary embodiments of the present disclosure, the system configured to make strategies and generate customized reports based on users in real-time, comprising a computing device 102/104 comprising a strategy making and customized report generating module 108 configured to deploy one or more agents in an interaction layer where one or more users interact with one or more customized reports. The strategy making and customized report generating module 108 configured to capture a variety of information related to the one or more users; and a knowledge base database 202 configured to store the information required to generate the one or more customized reports in different ways for the one or more users on the computing device 102/104, the knowledge base database 202 resides a strategy processor 204 configured to decide one or more strategies by at least one of: looking at past data learned over time through a plurality of resources which is stored in the knowledge base database 202; and by taking inputs from the one or more users at the start of a deployment phase on the computing device 102/104; one or more feedbacks collected by the one or more agents in the interaction layer are passed on to the strategy processor 204, the strategy processor 204 configured to store and use the one or more feedbacks and to update the one or more strategies as and when required; the strategy processor 204 also configured to decide one or more structural properties for one or more insights and send the one or more structural properties to the knowledge base database; the knowledge base database 202 configured to update the one or more insights and the one or more customized reports as per one or more language strategy tables, the strategy processor 204 configured to share the one or more customized reports with the one or more users on the computing device 102/104 and the one or more agents deployed on the interaction layer configured to record how the one or more users interacts with the one or more customized reports and start learning from the one or more customized reports, the one or more agents captures implicit as well as explicit variables from the one or more users as well the one or more customized reports and sends the one or more customized reports to the strategy processor 204 as the one or more feedbacks to the one or more strategies and one or more communication policies, are chosen.

According to exemplary embodiments of the present disclosure, the knowledge base database 202 is configured to generate the one or more insights and the strategy processor 204 configured to modify the one or more insights and present the one or more insights to the one or more users on the computing device 102/104. The one or more strategies comprising one or more short-term strategies, one or more medium-strategies, and one or more long-term strategies. The strategy processor 204 is configured to interact with the knowledge base database to get one or more communication models on the computing device 102/104. The strategy processor 204 is configured to decide one or more semantic and structural changes are to be made to the one or more customized reports on the computing device 102/104. The one or more semantic and structural changes comprising what tone is used, and how to structure a verbose. The knowledge base database 202 is configured to keep learning through at least one of: the one or more feedbacks collected by the one or more agents deployed in the interaction layer; and one or more online learning sources. The knowledge base database 202 is configured to house one or more language strategy tables configured to hold a semantic information. The strategy making and customized report generating module 108 comprising a collector module 308 configured to act as an interface between the one or more agents deployed on the interaction layer and interacts with the one or more users on the computing device 102/104. The collector module 308 is configured to update the knowledge base database 202 with the one or more strategies. The strategy processor 204 comprising a memory 310 configured to store one or more executed strategies. The strategy processor 204 is configured to use the memory 310 to check a past history of executed results and design the one or more strategies.

According to exemplary embodiments of the present disclosure, the method for making strategies and generating customized reports based on users in real-time, comprising: deploying one or more agents on the strategy making and customized report generating module 108 in an interaction layer where one or more users interacts with one or more customized reports on a computing device 102/104, obtaining one or more user inputs about one or more strategies by the strategy making and customized report generating module 108 for an initial configuration on the computing device 102/104, the one or more user inputs stored in a memory 310 and gets user data by the strategy making and customized report generating module 108 to generate the one or more customized reports on the computing device 102/104, generating one or more insights by the knowledge base database 202 on the computing device 102/104 based on user data, deciding a language semantic for the one or more insights by the strategy processor 204 using data from the collector module 308 and past history of strategies executed on the computing device 102/104, the strategy processor 204 configured to send the language semantic to the knowledge base database 202, whereby the knowledge base database 202 is configured to update the one or more insights and the one or more customized reports as per one or more language strategy tables, presenting the one or more customized reports by the knowledge base database 202 to the one or more users on the computing device 102/104, collecting user's interaction data and one or more feedbacks on the strategy making and customized report generating module 108 from the one or more agents and sending the one or more feedbacks to the knowledge base database 202 and the strategy processor 204, calculating the one or more strategies based on the pre-decided goals, as to how successful is the current strategy, making changes to the one or more strategies by the strategy processor 204 and saves the one or more strategies in the memory 310, whereby the knowledge base database 202 configured to learn the one or more feedbacks, providing one or more executed strategies and reward metric information to the strategy processor 204 from the collector module 308.

According to exemplary embodiments of the present disclosure, a computer program product comprising a non-transitory computer-readable medium having a computer-readable program code embodied therein to be executed by one or more processors, said program code including instructions to: deploy one or more agents on the strategy making and customized report generating module 108 in an interaction layer where one or more users interacts with one or more customized reports on a computing device 102/104, obtains one or more user inputs regarding one or more strategies by the strategy making and customized report generating module 108 for an initial configuration on the computing device 102/104, the one or more user inputs stored in a memory 310 and gets user data by the strategy making and customized report generating module 108 to generate the one or more customized reports on the computing device 102/104, generate one or more insights by the knowledge base database 202 on the computing device 102/104 based on user data, decide a language semantic for the one or more insights by the strategy processor 204 using data from the collector module 308 and past history of strategies executed on the computing device 102/104, the strategy processor 204 configured to send the language semantic to the knowledge base database 202, whereby the knowledge base database 202 is configured to update the one or more insights and the one or more customized reports as per one or more language strategy tables, present the one or more customized reports by the knowledge base database 202 to the one or more users on the computing device 102/104, collect user's interaction data and one or more feedbacks on the strategy making and customized report generating module 108 from the one or more agents and sending the one or more feedbacks to the knowledge base database 202 and the strategy processor 204, calculate the one or more strategies based on the pre-decided goals, as to how successful is the current strategy, make changes to the one or more strategies by the strategy processor 204 and saves the one or more strategies in the memory 310, whereby the knowledge base database 202 configured to learn the one or more feedbacks, provide one or more executed strategies and reward metric information to the strategy processor 204 from the collector module 308.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A system configured to make strategies and generate customized reports based on users in real-time, comprising:
a computing device comprising a strategy making and customized report generating module configured to deploy one or more agents in an interaction layer where one or more users interact with one or more customized reports, whereby the strategy making and customized report generating module configured to capture a variety of information related to the one or more users; and
a knowledge base database configured to store the information required to generate the one or more customized reports in different ways for the one or more users on the computing device, the knowledge base database resides a strategy processor configured to decide one or more strategies by at least one of: looking at past data learned over time through a plurality of resources which is stored in the knowledge base database; and by taking inputs from the one or more users at the start of a deployment phase on the computing device; one or more feedbacks collected by the one or more agents in the interaction layer are passed on to the strategy processor, whereby the strategy processor configured to store and use the one or more feedbacks and to update the one or more strategies as and when required; the strategy processor also configured to decide one or more structural properties for one or more insights and send the one or more structural properties to the knowledge base database; the knowledge base database configured to update the one or more insights and the one or more customized reports as per one or more language strategy tables; the strategy processor configured to share the one or more customized reports with the one or more users on the computing device and the one or more agents deployed on the interaction layer configured to record how the one or more users interacts with the one or more customized reports and start learning from the one or more customized reports, the one or more agents captures implicit as well as explicit variables from the one or more users as well the one or more customized reports and sends the one or more customized reports to the strategy processor as the one or more feedbacks to the one or more strategies and one or more communication policies, are chosen.

2. The system of claim 1, wherein the knowledge base database is configured to generate the one or more insights and the strategy processor configured to modify the one or more insights and present the one or more insights to the one or more users on the computing device.

3. The system of claim 1, wherein the one or more strategies comprising one or more short-term strategies, one or more medium-strategies, and one or more long-term strategies.

4. The system of claim 1, wherein the strategy processor is configured to interact with the knowledge base database to get one or more communication models on the computing device.

5. The system of claim 1, wherein the strategy processor is configured to decide one or more semantic and structural changes are to be made to the one or more customized reports on the computing device.

6. The system of claim 5, wherein the one or more semantic and structural changes comprising what tone is used, and how to structure a verbose.

7. The system of claim 1, wherein the knowledge base database is configured to keep learning through at least one of: the one or more feedbacks collected by the one or more agents deployed in the interaction layer; and one or more online learning sources.

8. The system of claim 1, wherein the knowledge base database is configured to house one or more language strategy tables configured to hold a semantic information.

9. The system of claim 1, wherein the strategy making and customized report generating module comprising a collector module configured to act as an interface between the one or more agents deployed on the interaction layer and interacts with the one or more users on the computing device.

10. The system of claim 9, wherein the collector module is configured to update the knowledge base database with the one or more strategies.

11. The system of claim 1, wherein the strategy processor comprising a memory configured to store one or more executed strategies.

12. The system of claim 11, wherein the strategy processor is configured to use the memory to check a past history of executed results and design the one or more strategies.

13. A method for making strategies and generating customized reports based on users in real-time, comprising:
deploying one or more agents on a strategy making and customized report generating module in an interaction layer where one or more users interacts with one or more customized reports on a computing device;
obtaining one or more user inputs regarding one or more strategies by the strategy making and customized report generating module for an initial configuration on the computing device, whereby the one or more user inputs stored in a memory and gets user data by the strategy making and customized report generating module to generate the one or more customized reports on the computing device;
generating one or more insights by a knowledge base database on the computing device based on user data;
deciding a language semantic for the one or more insights by a strategy processor using data from a collector module and past history of strategies executed on the computing device, the strategy processor configured to send the language semantic to the knowledge base database, whereby the knowledge base database configured to update the one or more insights and the one or more customized reports as per one or more language strategy tables;
presenting the one or more customized reports by the knowledge base database to the one or more users on the computing device;
collecting user's interaction data and one or more feedbacks on the strategy making and customized report generating module from the one or more agents and sending the one or more feedbacks to the knowledge base database and the strategy processor;
calculating the one or more strategies based on the pre-decided goals, as to how successful is the current strategy; and
making changes to the one or more strategies by the strategy processor and saves the one or more strategies in a memory, whereby the knowledge base database configured to learn the one or more feedbacks.

14. The method of claim 13, further comprising a step of providing one or more executed strategies and reward metric information to the strategy processor from the collector module.

15. A computer program product comprising a non-transitory computer-readable medium having a computer-readable program code embodied therein to be executed by one or more processors, said program code including instructions to:
deploy one or more agents on a strategy making and customized report generating module in an interaction layer where one or more users interacts with one or more customized reports on a computing device;
obtaining one or more user inputs regarding one or more strategies by the strategy making and customized report generating module for an initial configuration on the computing device, whereby the one or more user inputs stored in a memory and gets user data by the strategy making and customized report generating module to generate the one or more customized reports on the computing device;
generate one or more insights by a knowledge base database on the computing device based on user data;
decide a language semantic for the one or more insights by a strategy processor using data from a collector module and past history of strategies executed on the computing device, the strategy processor configured to send the language semantic to the knowledge base database, whereby the knowledge base database configured to update the one or more insights and the one or more customized reports as per one or more language strategy tables;
present the one or more customized reports by the knowledge base database to the one or more users on the computing device;
collect user's interaction data and one or more feedbacks on the strategy making and customized report generating module from the one or more agents and sending the one or more feedbacks to the knowledge base database and the strategy processor;
calculate the one or more strategies based on the pre-decided goals, as to how successful is the current strategy; and
make changes to the one or more strategies by the strategy processor and saves the one or more strategies in a memory, whereby the knowledge base database configured to learn the one or more feedbacks.
